(19) United States
(12) Patent Application Publication
(10) Pub. No.: US 2003/0142432 A1
(43) Pub. Date: Jul. 31, 2003

(54) Storage media reading system and semiconductor integrated circuit device

(75) Inventors: Hiroyasu Yoshizawa, Ome (JP); Yoichiro Kobayashi, Ome (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 10/330,340

(22) Filed: Dec. 30, 2002

(30) Foreign Application Priority Data
Jan. 28, 2002 (JP) 2002-018370

(51) Int. Cl. G11B 5/02

(52) U.S. Cl. 360/67

(57) ABSTRACT

There is provided a semiconductor integrated circuit for magnetic recording including a write circuit which may be operated with the power supply voltage of 5V system without any problem on the dielectric strength thereof and also assures high speed data write operation to media of the magnetic recording system and a high-speed and highly reliable storage media reading system which has employed the same semiconductor integrated circuit. The write circuit described above is configured to apply a drive voltage to a head through superimposition so that a write current generates over-shoot when the current is inverted by providing the write head with a voltage and moreover a protection element is provided to protect a switch MOSFET for the current switching from a high voltage which is applied to the write head when the current is inverted.

### BACKGROUND OF THE INVENTION

The present invention relates to a semiconductor integrated circuit comprising a write circuit for driving a head with a write signal in the magnetic recording type media reading system and a magnetic recording system utilizing the same circuit and more specifically to the technology which may be effectively applied, for example, to a hard disk apparatus.

A hard disk apparatus has been provided with a read/write semiconductor integrated circuit (hereinafter, referred to as a read/write IC) for driving a magnetic head to read data by inverting direction of magnetic pole of a magnetic material at the surface of a magnetic disk as a recording medium and reading a data recorded on the magnetic disk and then amplifying such data. This read/write IC is usually provided at the side surface of a carriage for shifting an arm provided with a magnetic head at the end point thereof and is connected to the magnetic head with a flexible cable which may be bent referred to as an FPC (Flexible Printed Circuit). In the hard disk apparatus including a plurality of magnetic disks, a read/write IC is configured as a multi-channel IC for processing signals of a plurality of heads provided to respective disks.

An existing magnetic disk apparatus has a disadvantage that a read/write speed for data is rather slow because it includes a physical operating portion unlike a semiconductor memory and therefore it has been expected to realize further improvement in the speed of data read/write operation. In order to improve data transfer speed in such magnetic disk apparatus, it is essential that the rotating speed of disk, namely of a spindle motor is improved and moreover accurate servo control for a voice coil motor to move such spindle motor and carriage must be assured. In addition, the read/write IC has also to be designed as a high performance circuit to amplify a high frequency signal.

### SUMMARY OF THE INVENTION

The applicant of the present invention has succeeded in development of a magnetic disk apparatus which can realize high speed rotation and accurate servo control even under such high speed rotation and a high performance read/write IC which enables high frequency operation and has applied the patent application (U.S. Ser. No. 09/902,581; filing date: Jul. 12, 2001).

The read/write IC of such patent application has used a voltage of 3.3V in place of the existing voltage of 5V as the power supply voltage in order to improve performance and reduce the power consumption. Moreover, as a head driving system during the write operation, a voltage driving system is substituted for the existing current driving system. In this voltage driving system, since the write speed becomes slower particularly when a voltage applied across the head terminal is low while a current is inverted, the preceding patent application has proposed a write circuit for driving the head with the power supply voltage of 3.3V in the steady state and applying a voltage through superimposition of the voltage pulse boosted from the power supply voltage while the current is inverted.

However, since the power supply voltage of 5V system is mainly used at present for the magnetic recording system in which a read/write IC is used, this read/write IC is often requested to operate with the power supply voltage of 5V. Therefore, the inventors of the present invention have discussed to see whether the read/write IC of the preceding patent application can be operated with the power supply voltage of 5V system without generation of any problem. As a result, it has been found that the read/write IC of the preceding patent application provides a fear for deterioration of reliability of circuit because a voltage higher than the dielectric strength is applied across the source and drain of a MOSFET forming a write circuit to which a high voltage is applied when a current is inverted.

A circuit having the configuration similar to that of the write circuit of the present invention is disclosed in the Japanese Unexamined Patent Application Publication No. 2000-101608. The write circuit of such preceding application is similar to the write circuit of the present invention in the point that a voltage pulse is superimposed to assure quick inversion rate when a current is inverted. However, in the present invention, a write current is positively overshot when a current is inverted, while in the preceding patent application, the circuit is operated to control such over-shoot of the write current. In this point, the present invention proposes the write circuit which is different in the operation principle from that of the preceding patent application.

Moreover, as a technology to avoid violence in the dielectric strength of the write circuit, it is considered to use a current drive type write circuit using the bipolar transistors Q11 to Q14 illustrated in FIG. 13. The circuit of FIG. 13 is capable of generating over-shoot of a write current by connecting a kind of resonance circuit consisting of a resistor R0 and a capacitor C0 to a head terminal. However, the write circuit consisting of this bipolar transistor can be used without any problem when it is used to the system of the ordinary write speed but provides a fear that sufficient over-shoot cannot be assured in the system of quick write speed which will be requested in future.

It is therefore an object of the present invention to provide a semiconductor integrated circuit for magnetic recording including a write circuit which may be operated with the power supply voltage of 5V system without any problem for dielectric strength of elements and a storage media reading system utilizing the same semiconductor circuit.

It is another object of the present invention to provide a semiconductor integrated circuit for magnetic recording including a write circuit which can write data at the high speed to storage media of the magnetic recording system and a storage media reading system utilizing the same semiconductor integrated circuit.

It is still further object of the present invention to provide a semiconductor integrated circuit for magnetic recording including a write circuit which can adjust amount of over-shoot of a steady current during the write operation and when a current is inverted and thereby realize the write operation in the optimum write characteristic for the system to be applied and a storage media reading system utilizing the same semiconductor integrated circuit.

The described and the other objects of the present invention and the novel features thereof will become apparent from the description of the present specification and the accompanying drawings.

The typical inventions of the inventions described in this specification are as follows.

That is, the invention of the present specification proposes a write circuit forming a storage media reading system which is provided with a first drive circuit to apply a steady current by driving a write head and a second drive circuit to temporarily apply a write current when a current is inverted in view of applying, to the head, a drive voltage by generating this drive voltage to control the write current to generate over-shoot when the current is inverted by superimposing the current applied to the head with two drive circuits and moreover providing a protection element to prevent application of a voltage higher than the dielectric strength to a switch MOSFET for current switching with a higher voltage applied to the write head when the current is inverted.

According to the means described above, quick write operation can be realized because a write current generates over-shoot when the current is inverted. Moreover, even when the write circuit including the switch MOSFET is configured to generate the drive voltage with which the write current generates over-shoot and then apply this drive voltage to the head, it is possible that a voltage higher than the dielectric strength is no longer applied to the switch MOSFET by means of the protection element. Moreover, since the head is driven with a voltage signal supplied from the write circuit, an output impedance of the write circuit can be lowered and thereby settling of current flowing to the head can be improved and quick write operation can also be realized.

Moreover, a means is preferably provided to the write circuit in order to adjust the steady current which is caused to flow into the head by means of the first drive circuit. More preferably, a means for adjusting over-shoot current flowing into the head by means of the second drive circuit is also provided. Accordingly, the write circuit for realizing the write operation in the optimum write characteristic for the system to be applied can also be realized.

### BRIEF DESCRIPTION OF THE DRAWINGS

FIG. 1 is a block diagram illustrating a configuration example of a semiconductor integrated circuit for magnetic recording to which the present invention is applied.

FIG. 2 is a block configuration diagram illustrating a schematic configuration of an example of a write circuit.

FIG. 3 is a timing chart illustrating the timings of a control pulse supplied to a write driver forming the write circuit and a write current caused to flow into a write head by means of the write circuit of the embodiment.

FIG. 4 is a timing chart illustrating the timings of pulse generated by a superimposed pulse generating circuit forming the write circuit.

FIG. 5 is a logic configuration diagram illustrating a practical configuration example of the superimposed pulse generating circuit forming the write circuit.

FIG. 6 a circuit diagram illustrating practical configuration examples of an amplifier and a logic gate circuit forming the superimposed pulse generating circuit.

FIG. 7 is a circuit diagram illustrating a practical configuration example of a delay amplifier forming the superimposed pulse generating circuit.

FIG. 8 is a circuit diagram illustrating a practical configuration example of a variable voltage circuit forming the superimposed pulse generating circuit.

FIG. 9 is a circuit diagram illustrating a practical circuit example of a write driver forming the write circuit.

FIG. 10 is a circuit diagram illustrating the other embodiment of the write driver forming the write circuit.

FIG. 11 is a circuit diagram illustrating the other embodiment of the write driver forming the write circuit.

FIG. 12 is a block diagram illustrating a configuration example of a hard disk apparatus as an example of a storage media reading system to which the present invention can be effectively applied.

FIG. 13 is a circuit diagram illustrating an ordinary example of the current drive type write circuit of the prior art.

### DETAILED DESCRIPTION OF THE PREFERRED EMBODIMENTS

The preferred embodiments of the present invention will be explained in detail with reference to the accompanying drawings.

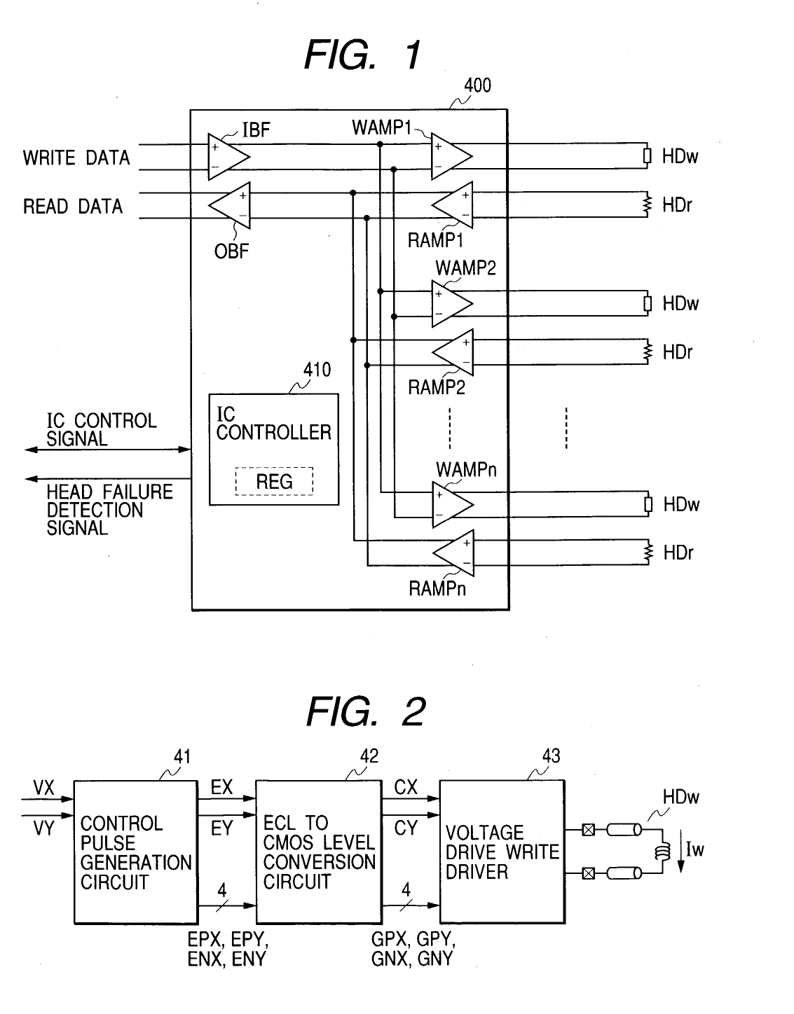

FIG. 1 illustrates a schematic configuration of a semiconductor integrated circuit (read/write IC) chip 400 for magnetic recording in relation to the present invention. The read/write IC of the embodiment is configured, although not particularly restricted, corresponding to an apparatus provided with a plurality of magnetic disks.

In FIG. 1, HDr is a read head consisting of an MR head (magneto-resistive head), while HDw is a write head. A set of the read head HDr and the write head HDw corresponds to a sheet of disk or one surface of a sheet of the disk.

A read/write IC 400 is configured with read amplifiers RAMP1, RAMP2, . . . , RAMPn connected to respective read heads HDr, write amplifiers WAMP1, WAMP2, . . . , WAMPn connected to respective write heads HDw, an input buffer IBF and an output buffer OBF for transmitting and receiving signal to and from a host signal processing LSI which is referred to as a data channel processor and a control circuit 410 for controlling a chip by receiving a control signal from a microcomputer as a system controller. This control circuit 410 is provided with a register REG to set operation mode or the like.

Next, an embodiment of the write circuit including a write amplifier provided in the read/write IC 400 will be explained. The write circuit of this embodiment suppresses power consumption by employing a voltage system in place of an ordinary current system of the prior art as the write head driving system.

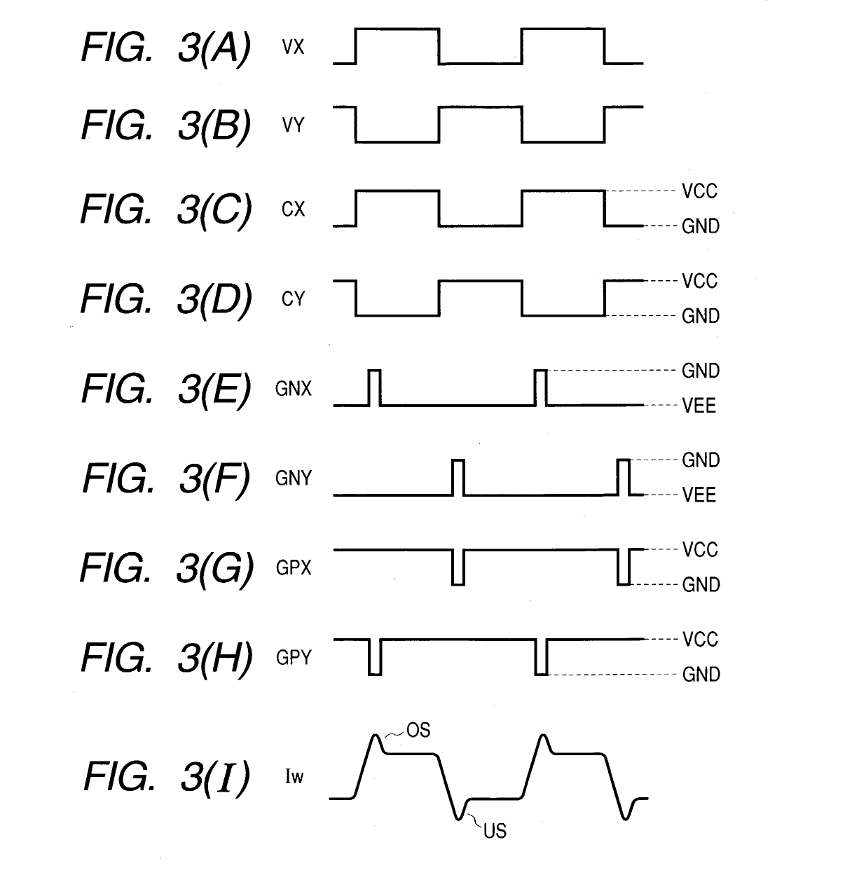

FIG. 3(I) is a waveform of a write current Iw to be applied to the write head HDw, while FIG. 2 illustrates a schematic configuration (block configuration diagram) of the write circuit including a write amplifier for applying such write current Iw to the write head HDw. The write circuit of this embodiment applies the write current Iw illustrated in FIG. 3(I) by applying a voltage obtained by combining the pulses of FIG. 3(C) and FIG. 3(D) and the pulses of FIG. 3(E) to FIG. 3(H) to the write head HDw.

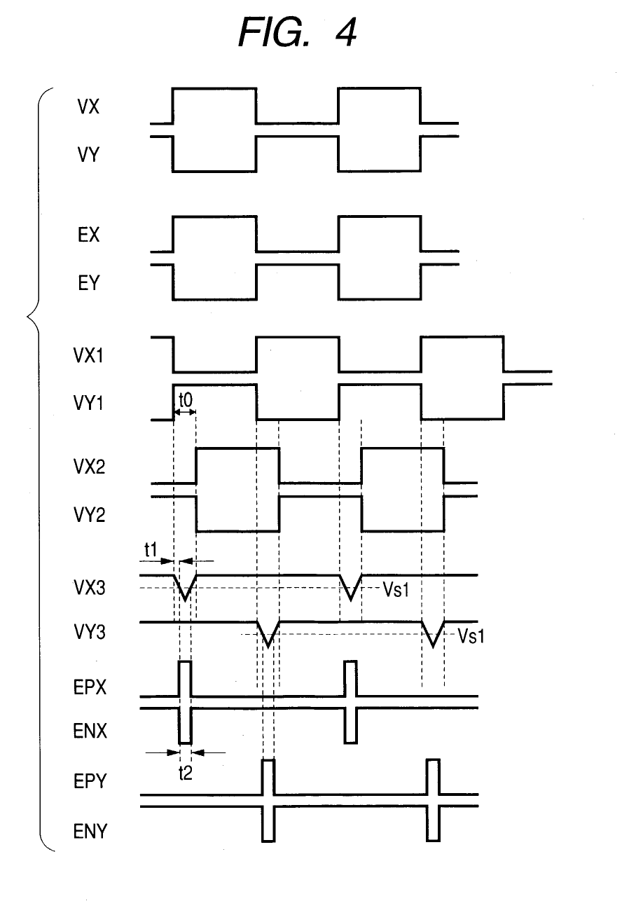

Therefore, the write circuit of FIG. 2 is configured with a superimposed pulse generating circuit 41 for generating superimposed pulses EX, EY, EPX, EPY, ENX, ENY of the ECL level based on the write signals VX, VY of FIG. 3(A) and FIG. 3(B), a level converting circuit 42 for converting the pulses EX, EY, EPX, EPY, ENX, ENY in the amplitude of the ECL level into the pulses CX, CY, GPX, GPY, GNX, GNY in the amplitude of the CMOS level and a write driver 43 as the write amplifier for driving the write head HDw with a voltage. The pulses EX, EY, EPX, EPY, ENX, ENY have the amplitude of ECL level and are identical in the timing to the pulses CX, CY, GPX, GPY, GNX, GNY. FIG. 4 illustrates the timing chart of the pulses EX, EY, EPX, EPY, ENX, ENY.

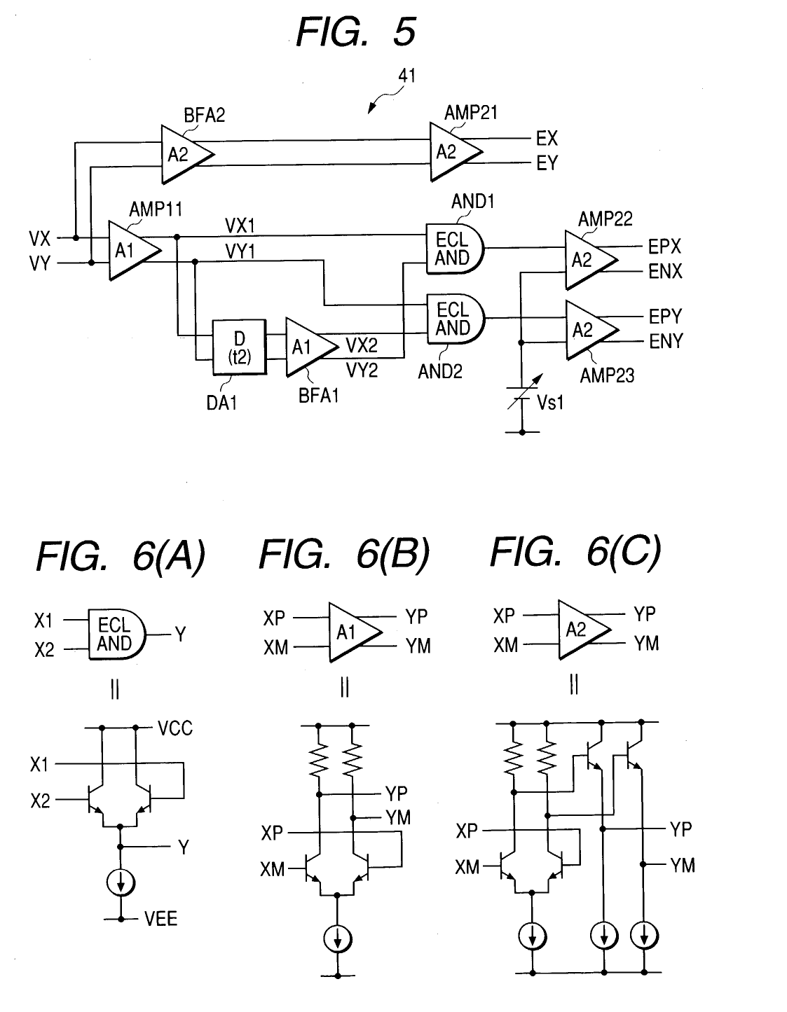

FIG. 5 illustrates a more practical configuration example of the superimposed pulse generating circuit 41 forming the write circuit. The superimposed pulse generating circuit 41 of this embodiment is composed of an input differential amplifier AMP11 forming an input stage, a delay amplifier DA1, buffer amplifiers BFA1, BFA2, logical product gates AND1, AND2 for generating a one-shot pulse depending on the rise and fall of the input pulses VX, VY, output differential amplifiers AMP21 to AMP23 forming an output stage and a variable voltage circuit Vs1 which gives a threshold voltage applied to one terminal of the output differential amplifiers AMP22 and AMP23.

The output differential amplifier AMP21 outputs pulses EX, EY in accordance with input pulses VX, VY, while the output differential amplifiers AMP22 and 23 output one-shot pulses EPX, ENX. The pulses EPX, ENX are positive and negative pulses generated in accordance with rise of the input pulse VX, while the pulses EPY and ENY are positive and negative pulses generated in accordance with rise of the input pulse (fall of VX).

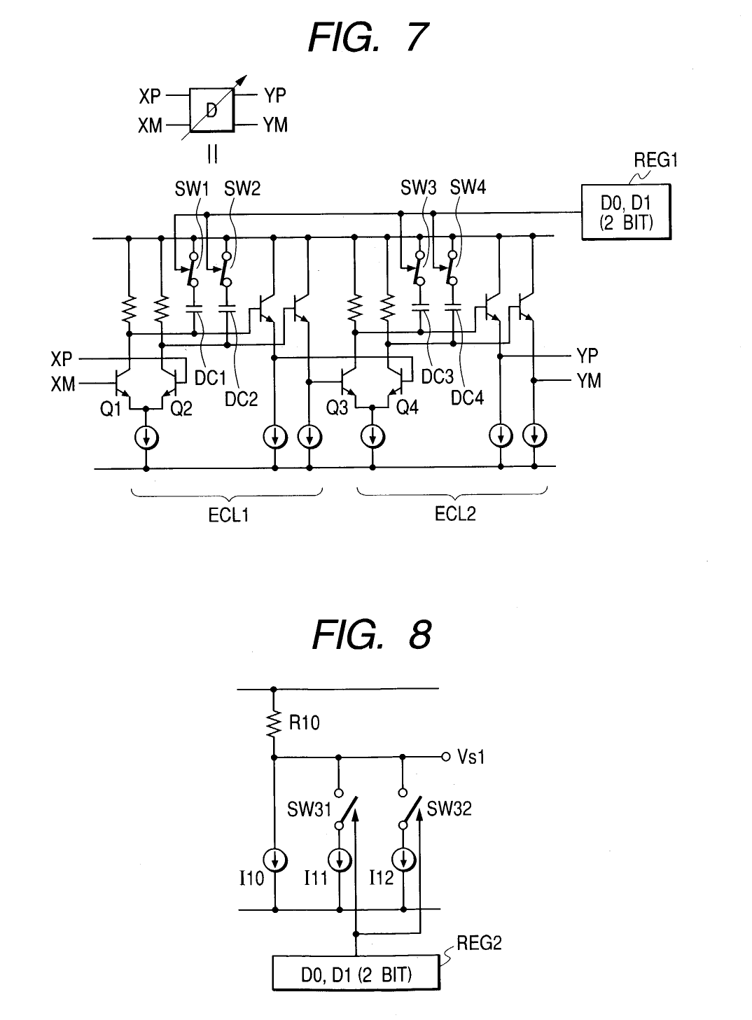

A practical circuit example of the logical product gates AND1, DA2 is illustrated in FIG. 6A, while a practical circuit example of the input differential amplifier AMP11 and buffer amplifier BFA1 is illustrated in FIG. 6(B), a practical circuit example of the buffer amplifier BFA2 and output differential amplifiers AMP11 to AMP13 is illustrated in FIG. 6(C), a practical circuit example of the delay amplifier DA1 is illustrated in FIG. 7 and a practical circuit example of the variable voltage circuit Vs1 is illustrated in FIG. 8, respectively.

The delay amplifier DA1 is provided to set the pulse width t0 of the signals VX3, VY3, moreover a phase difference t1 for the output pulses EX, EY of the one-shot pulses EPX to ENY, as illustrated in FIG. 4, by controlling amount of delay of the signals VX2, VY2 and is composed, as illustrated in FIG. 7, of the ECL circuits ECL1, ECL2 of the two stages and a control register REG1. Capacitance elements DC1, DC2 and switches SW1, SW2 are connected between the bases of output emitter follower transistors Q1, Q2 of the ECL circuit ECL1 of the preceding stage and the power supply voltage Vcc, and moreover capacitance elements DC3, DC4 and switches SW3, SW4 are connected between the bases of the output emitter follower transistors Q3, Q4 of the ECL circuit ECL2 of the successive stage and the power supply voltage Vcc. A delay time of this delay amplifier DA1 is determined depending on connection and disconnection of the capacitance elements DC1 to DC4 as the load capacitance to the ECL circuit, in accordance with ON and OFF states of the switches SW1 to SW4 determined by the setting codes D0, D1 of the register REG1.

The output differential amplifiers AMP22, AMP23 are provided to set the pulse width t2 of the one-shot pulses EPX to ENY, and the pulse width t2 can be adjusted by varying the threshold voltage (Vs1) inputted to one terminal of such output differential amplifiers. A phase difference t1 for the outputs EX, EY of the one-shot pulses EPX to ENY is determined with correlation of the pulse width t2 of the one-shot pulses EPX to ENY and the pulse width t1 of the signals VX3, VY3. The variable voltage circuit Vs1 which gives the threshold voltage applied to the reference terminal side of the output amplifiers AMP22, AMP23 is composed, for example as illustrated in FIG. 8, of a series circuit of a resistor R10 and a constant current source 110, a plurality of constant current sources 111, 112 and switches SW31, SW32 connected in series to the current sources 111, 112. Thereby, the output voltage Vs1 can be adjusted by switching the current flowing to the resistor R10 by changing the setting value of the register REG2.

An ECL-CMOS level converting circuit 42 can be configured with a circuit similar to the well known level converting circuit and therefore the practical circuit example is not illustrated here.

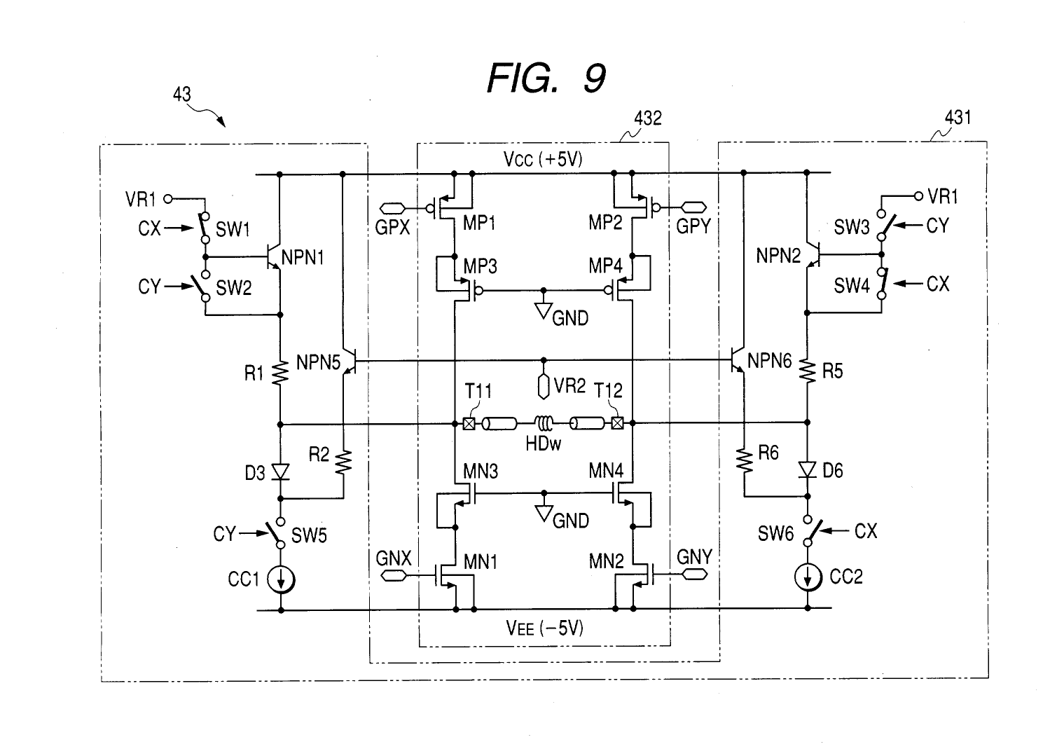

FIG. 9 illustrates a practical circuit example of the write driver 43 forming the write circuit. The write driver 43 of this embodiment is composed of a first head drive circuit 431 and a second head drive circuit 432 which causes a current to flow in any direction by driving with voltage the write head HDw provided between the heat connecting terminals T11, T12 in the push-pull operation from both directions.

The first head drive circuit 431 is continuously operated during the write cycle with the control pulses CX, CY of the FIG. 3(C) and FIG. 3(D), while the second head drive circuit 432 is temporarily operated only for a comparatively short period (t2) immediately after the switching of current by the control pulses GNX, GNCY, GPX, GPY of FIG. 3(E) to FIG. 3(H). Namely, the first head drive circuit 431 operates as a steady drive circuit which causes only a steady part of the write current Iw of FIG. 3(I) to flow into the write head HDw and the second head drive circuit operates as an accelerated drive circuit which causes a current of the over-shoot portions OS, US to flow when the write current Iw is inverted. These drive circuits 431, 432 will be described in further detail.

The first drive circuit (steady drive circuit) 431 is provided with transistors NPN1, NPN2, NPN5, NPN6 of which collectors are connected to the power supply voltage VCC, a resistor R1, a diode D3, a switch SW5 and a constant power source CC1 connected in series to the NPN1, a resistor R5, a diode D6, a switch SW6 and a constant power source CC2 connected in series to the NPN2, a resistor R2 connected between the emitter of the NPN5 and the cathode of the diode D1, a resistor R6 connected between the emitter of the NPN6 and the cathode of the diode D2, a switch SW1 connected between the base of the NPN1 and a constant voltage terminal VR1, a switch SW2 connected between the base and emitter of the NPN1, a switch 3 connected between the base of the NPN1 and the constant voltage terminal VR1 and a switch SW4 connected between the base and emitter of the NPN2. The transistors NPN5 and NPN6 receive a constant voltage VR2 at the bases to operate as the constant current sources. As the constant voltage source VR1, a voltage of 2V, for example, is selected and as the constant voltage source VR2, a voltage of 3V is selected.

The switches SW1, SW4, SW6 are controlled for ON and OFF states with the pulse CX outputted from the level converting circuit 42, while the switches SW2, SW3, SW5 with the pulse CY4 outputted from the level converting circuit 42. As illustrated in FIG. 3, since the pulses CX and CY are signals having inverted phases, when the CX is changed to high level, the switches SW1, SW4, SW6 become conductive and the transistor NPN1 turns ON and the NPN2 operates as a backward diode. Therefore, a current flows to the head connecting terminal T12 from T11. Moreover, in this case, the transistor NPN6 turns ON, causing a potential of the head connecting terminal T12 to be protected from excessively lower voltage. The amplitude of the flat part of the write current waveform Iw of FIG. 3(I) is determined with a base potential difference ΔV (when VR2=0V, ΔV=VR1) between the transistors NPN1 and NPN6.

In addition, after the predetermined delay time from the start of current to flow to the head connecting terminal T12 from T11 after the transistor NPN1 is turned ON, the switch MOSFETs MP1, MN2 are turned ON. As a result, the write current Iw in the over-shoot condition as indicated by OS of FIG. 3(I) flows into the write head HDw. In this case, the transistor NPN6 is turned OFF because a backward bias voltage is applied thereto.

On the other hand, when the pulse CY changes to high level, the switches SW2, SW3, SW5 become conductive and the transistor NPN2 is turned and the NPN1 operates as a backward diode. Therefore, a current flows to the head connecting terminal T11 from T12 and after the predetermined delay time has passed, the switch MOSFETs MP2, NN1 are turned ON. As a result, the writer current Iw in the over-shoot condition as indicated as US of FIG. 3(I) flows into the write head HDw.

The second head drive circuit (accelerated drive circuit) 432 is provided with four MOSFETs MP1, MP2, MN1, MN2 provided between the head connecting terminals T11, T12 and power source voltage VCC (+5V) and between the T11, T12 and the power source voltage VEE (−5V). These switch MOSFETs MP1 to MN2 are respectively controlled for ON and OFF states with the control pulses GPX, GPY, GNX, GNY outputted from the level converting circuit 42. Therefore, the power source voltages VCC and VEE are applied to the head connecting terminals T11, T12 to give a large drive voltage corresponding to the power source voltage difference (VCC-VEE) to the write head HDw. As explained above, high speed write operation can be performed by giving a large drive voltage to the head when data is inverted.

Moreover, in this embodiment, since the power supply voltages VCC, VEE are respectively +5V and −5V to give a large drive voltage to the head when the data is inverted and these voltages are applied to the head terminal with the switch MOSFETs MP1, MP2, MN1, MN2, the write current Iw which rapidly changes by overcoming a back electromotive force generated with an inductance element remaining on the head and transmission line can be applied. However, when such large power supply voltage is used, a voltage higher than the dielectric strength is applied across the source and drain of the switch MOSFETs MP1, MP2, MN1, MN2. Therefore, in this embodiment, the MOSFETs MP3, MP4, MN3, MN4 to which the ground potential GND is applied at the gate terminals thereof are provided in series to these switch MOSFETs MP1, MP2, MN1, MN2 in order to protect the voltage across the sources and drains of the MP1, MP2, MN1, MN2 with MP3, MP4, MN3, MN4.

When it is considered in the second drive circuit 432 that the MP1 and MN2 among switch MOSFETs MP1 to MN2 are turned ON while the control pulse GNX is “L” (=VEE), GNY is “H” (=GND), GPX is “L” (=GND) and GPY=“H” (=VCC), the power supply voltage VCC (+5V) is applied to the terminal T11 and the power supply voltage VEE (−5V) is applied to the terminal T12. Accordingly, a drain voltage of the switch MOSFET MN1 in the OFF state rises and if the MOSFET MN3 is not provided, a voltage of about 10V is applied across the source and drain of the switch MOSFET MN1, breaking the protection of dielectric strength.

However, in this embodiment, since the MOSFET MN3 for protection is provided across the head connection terminal T11 and the drain of switch MOSFET MN1, rise of drain voltage of MN1 is stopped at the potential near to the ground potential GND as the gate voltage of MN3. As a result, rise of the source-drain voltage of MN1 and MN3 stops at the voltage about 5V and the dielectric strength of both transistors can be protected. This can be also applied to the other switch MOSFETS MN2, MP1, MP2.

Moreover, the write driver 43 in this embodiment is capable of preventing reflection of the write voltage at the terminals T11 and T12 by setting an output impedance of the drive circuit to be matched with an impedance of the transmission line connecting between the write head HDw and connecting terminals T11, T12 through adjustment of size and gate voltage of the MOSFETs MP3, MP4, MN3, MN4 for protection of dielectric strength.

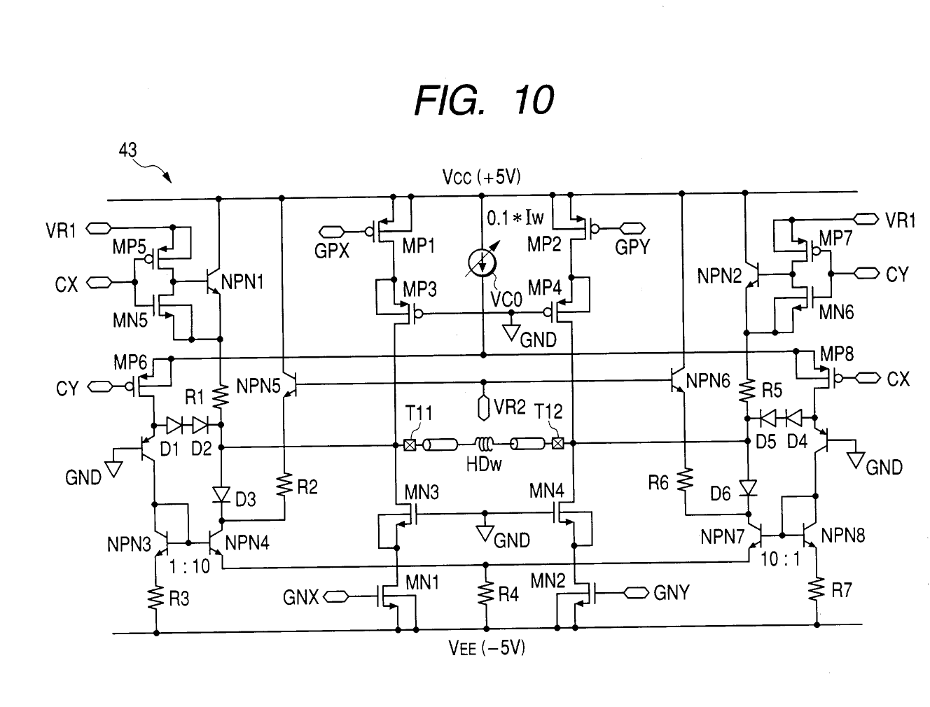

FIG. 10 illustrates a modification example of the write driver 43. In this modification, as the switches SW1 to SW4 in FIG. 9 which give the base voltages of the transistors NPN1, NPN2, the P-channel MOSFETs MP5, MP7 and N-channel MOSFETs MN5, MN6 are used. Since the P-channel MOSFET and N-channel MOSFET operate complementarily upon reception of the same signal at the gates thereof, the transistors MP5 and MN5 (SW1 and SW2) can be controlled with only one control pulse CX, while the transistors MP7 and MN6 (SW3 and SW4) can be controlled with only one control pulse CY by introducing the configuration described above.

Moreover, this modification example is configured so that the switch SW5 and constant current source CC1 of FIG. 9 are formed of a current Miller circuit consisting of the transistors NPN3 and NPN4 of which bases are connected in common and the switch MOSFET MP6 for turning ON and OFF the current flowing into the current Miller circuit depending on the control pulse CY, the switch SW6 and constant current source CC2 of FIG. 9 are formed of a current Miller circuit consisting of the transistors MPN7, NPN8 and the switch MOSFET MP8 for turning ON and OFF the current flowing into the current Miller circuit depending on the control pulse CX, and a constant current is supplied to the switch MOSFETs MP8 and MP6 from a common variable current source VC0.

Thereby, the write driver 43 of this embodiment can adjust a current Iw flowing to the write head HDw under the steady condition by controlling a current of the variable constant current source VC0. Although not particularly restricted, respective emitter resistors of the transistors NPN4 and NPN7 forming the current Miller circuit are also provided as the common resistor R4.

In addition, in this embodiment, the write current Iw of the predetermined current value is allowed to flow by designing the variable constant current source VC0 to permit a current, under the steady condition, to flow in the amplitude of about 1/10 the current to be applied to the write head and also designing an emitter size ratio of the transistors NPN3 and NPN4 forming the current Miller circuit and an emitter size ratio of the transistors NPN8 and NPN7 to become 1:10.

Accordingly, the write current Iw can be adjusted with control of only one current source and the power consumption of the circuit as a whole can also be controlled. The transistor PNP1 between the MOSFET MP6 and transistor NPN3 and the diodes D1, D2 between the MOSFET MP6 and head terminal T11 are provided to adjust potential of node in the circuit and to prevent saturation of NPN4.

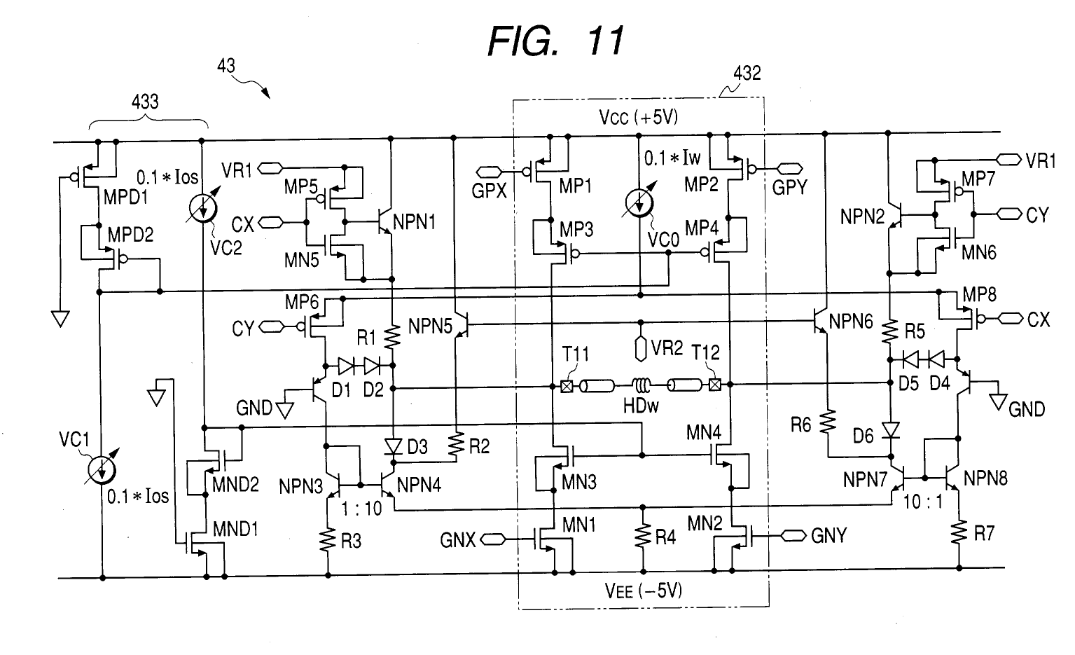

FIG. 11 illustrates the other circuit example of the write driver 43. In this embodiment, an ON resistance of the MOSFETs MP3, MP4, MN3, MN4 is changed to adjust an over-shoot current by providing a gate control circuit for controlling gate voltages of the MOSFETs MP3, MP4, MN3, MN4 for protection of dielectric strength forming the second head drive circuit (accelerated drive circuit) 432.

In more practical, a MOSFET MPD2 which is connected in common to the gates of the MOSFETs MP3, MP4 for protecting the dielectric strength to form a current Miller circuit, a MOSFET MPD1 connected in series between the MOSFET MPD2 and the power supply voltage VCC, a variable current source VC1 connected between the MPD2 and power supply voltage VEE, a MOSFET MND2 which is connected in common to the gates of the MOSFETs MN3, MN4 for protecting the dielectric strength to form a current Miller circuit, a MOSFET MND1 which is connected in series between the MOSFET MND2 and the power supply voltage VEE and an over-shoot current adjusting circuit 433 which is formed of the variable current source VC2 connected between the MND2 and the power supply voltage VCC are provided.

Here, in this embodiment, the variable current sources VC1, VC2 are configured to allow a current to flow in the level of about 1/10 the level of desired over-shoot current Ios and the over-shoot current Ios of the desired current value is allowed to flow by designing the gate size ratio of the MOSFETs MPD2, MP3, MP4 forming the current Miller circuit and the gate size ratio of the MND2, MN3, MN4 to become 1:10.

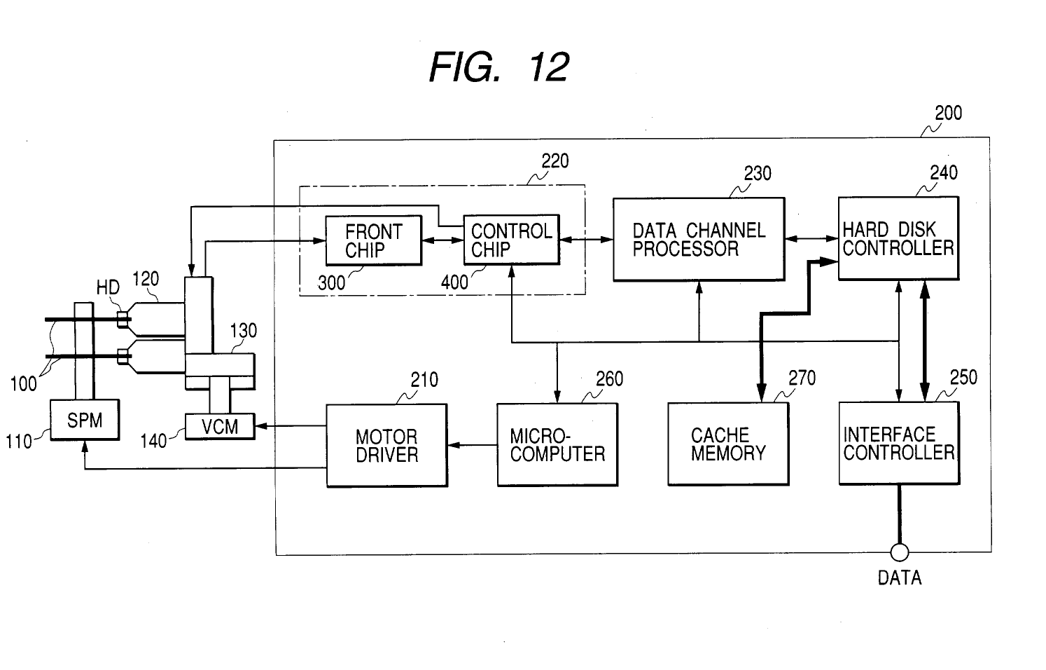

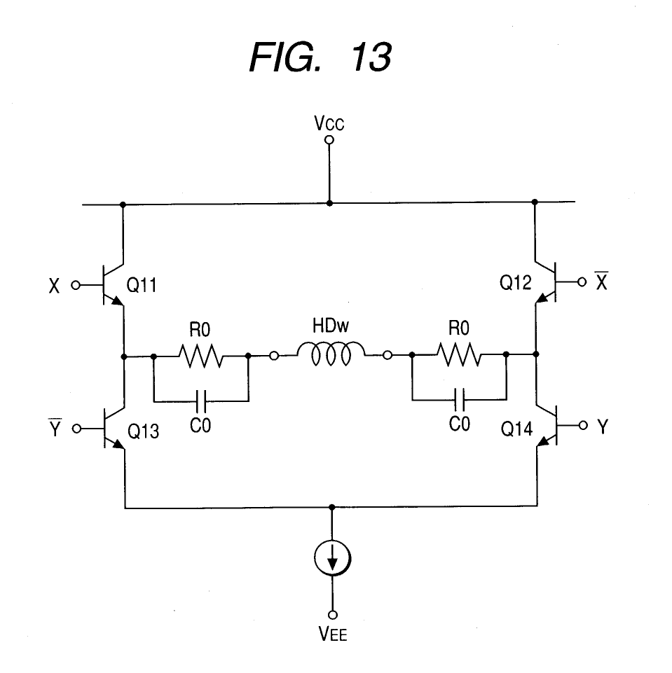

FIG. 12 is a block diagram of a configuration example of the hard disk apparatus as an example of the storage media reading system to which the present invention can be applied effectively.

In FIG. 12, 100 is a storage medium like a magnetic disk; 110, a spindle motor for rotating the magnetic disk 100; 120, an arm including a magnetic head (including the write head and read head) at the end part thereof; 130, a carriage for holding the arm 120 to rotate; 140, an actuator like a voice-coil for moving the carriage 130.

A reference numeral 210 is a motor driver composed of a spindle motor drive circuit and a voice-coil motor drive circuit for driving the spindle motor 110 and voice-coil motor 130. A reference numeral 220 is a read/write IC which is fitted to the side surface or the like of the carriage 130 for reading an amplified current in accordance with change of magnetism detected by the magnetic head HD, sending the read signal to a data channel processor 230 and driving the magnetic head HD by amplifying a write pulse signal from the data channel processor 230.

A reference numeral 240 is a hard disk controller for conducting error correction process by fetching a read data transmitted from the data channel processor 230 and outputting the write data from the host to the data charnel processor 230 through the error correction encoding process. The data channel processor 230 performs modulation/demodulation process suitable for digital magnetic recording and signal process such as waveform shaping or the like considering the magnetic recording characteristic.

A reference numeral 250 is an interface controller to conduct exchange and control of data between this system and external apparatuses. The hard disk controller 240 is connected to a host computer such as the microcomputer of a personal computer via the interface controller 250. A reference numeral 260 is a system controller consisting of a microcomputer for totally controlling the system as a whole and calculating a sector position or the like based on an address information supplied from the hard disk controller 240. A reference numeral 270 is a cache memory for buffer for temporarily storing the read data read in the higher speed from the magnetic disk. The microcomputer 260 judges an operation mode based on the signal from the hard disk controller 24 and controls entire part of the system corresponding to the operation mode.

The motor driver 210 is composed of the spindle motor drive circuit and voice-coil motor drive circuit. The spindle motor drive circuit is servo-controlled with a signal outputted from the microcomputer 260 to make constant the relative speed of head, while the voice-coil motor drive circuit is also servo-controlled to attain the matching of the center of head to the center of track.

A hard disk control system 200 is configured with the read/write IC 220, data channel processor 230, hard disk controller 240, interface controller 250, microcomputer 260 and cache memory 270, while a hard disk apparatus as an example of the storage media reading system is configured with the control system 200, magnetic disk 100, spindle motor 110, magnetic head HD and voice-coil motor 130.

The present invention has been described previously based on the preferred embodiments thereof but the present invention is of course never limited to the above-described embodiments and allows various changes or modification within the scope of the appended claims thereof. For example, the write circuit described above is only an example and any type of circuit, which can generate an over-shoot current on the basis of voltage drive when data is inverted, may be used.

In above description, the present invention has been applied to a hard disk apparatus which is the main application field thereof. However, the present invention is not limited only to the hard disk apparatus and can also be introduced into a magnetic disk apparatus utilizing flexible magnetic disks.

The typical effects of the present invention will be summarized below.

That is, according to the present invention, it is possible to realize a semiconductor integrated circuit for magnetic recording operation including a write circuit which may be operated with the power supply voltage of 5V system without generation of any problem on the dielectric strength of components and a highly reliable storage media reading system which assures high speed operation by introducing the same semiconductor integrated.

Moreover, it is also possible to attain a semiconductor integrated circuit for magnetic recording operation which can adjust, during the data write operation, the amount of over-shoot when the steady current flows and when the current is inverted and can also realize easily the optimum write characteristic for the system to be applied and a storage media reading system to which the same semiconductor integrated circuit is employed.

What is claimed is:

1. A semiconductor integrated circuit comprising: a first drive circuit for making a steady current flow by driving a magnetic head with a voltage; a second drive circuit for temporarily making a write current flow when a current is inverted; and a write circuit for generating a drive voltage and then applying to the head to generate over-shoot of the write current when the current is inverted by superimposing the current flowing into the head by a couple of drive circuits, wherein said first and second drive circuits are driven with the identical power supply voltage, and wherein said write circuit is provided with a switch field effect transistor for switching the flowing direction of the current flowing into the head and a protection element for preventing a voltage higher than the dielectric strength from being applied to the switch field effect transistor by a high voltage applied to the write head when the current is inverted.

2. A semiconductor integrated circuit according to claim 1, wherein said second drive circuit comprises: a first field effect transistor connected between a first power supply voltage terminal and a first head connecting terminal; a second field effect transistor connected between the first power supply voltage terminal and a second head connecting terminal; a third field effect transistor connected between a second power supply voltage terminal and the first head connecting terminal; and a fourth field effect transistor connected between the second power supply voltage terminal and the second head connecting terminal, and said protection element is provided respectively corresponding to said first to fourth field effect transistors.

3. A semiconductor integrated circuit according to claim 2, wherein said protection element is a field effect transistor which is connected respectively to said first to fourth field effect transistors with the source/drain paths connected in series.

4. A semiconductor integrated circuit according to claim 3, comprising an over-shoot current adjusting means for adjusting amount of over-shoot of a current caused to flow into said magnetic head by said second drive circuit, by controlling a gate voltage of the field effect transistor as said protection element.

5. A semiconductor integrated circuit according to claim 1, comprising a steady current adjusting means for adjusting a current value of the steady current caused to flow into said magnetic head by said first drive circuit.

6. A semiconductor integrated circuit according to claim 2, wherein said write circuit comprises a first pulse generating means for generating a control pulse to control said first drive circuit, and a second pulse generating means for generating a gate control pulse of said first to fourth field effect transistors forming said second drive circuit, and said second pulse generating means is provided with a pulse width adjusting means for adjusting a pulse width of said gate control pulse.

7. A semiconductor integrated circuit according to claim 6, wherein said second pulse generating means comprises a timing adjustment means for adjusting the timing for change of said gate control pulse to the timing for change of said control pulse for controlling said first drive circuit.

8. A semiconductor integrated circuit according to claim 1, further comprising an amplifying circuit for amplifying a read signal from said magnetic head.

9. A storage media reading system comprising: a semiconductor integrated circuit according to claim 1; a media drive means for driving storage media; a media drive circuit for electrically controlling and driving said media drive means; a head holding means including a head for reading data stored in said recording medium, outputting the data as a read electric signal and magnetically recording the data to said recording medium; a moving means for moving said head holding means; a signal processing circuit for demodulating said read signal amplified with said semiconductor integrated circuit, modulating the write data to a signal which is suitable for magnetic recording and then supplying the signal to said semiconductor integrated circuit, and a controller for controlling said media drive circuit, semiconductor integrated circuit, and signal processing circuit.

10. A storage media reading system according to claim 9, wherein said semiconductor integrated circuit is provided to said moving means.
